(19) United States
(12) Patent Application Publication
(10) Pub. No.: US 2015/0030801 A1
(43) Pub. Date: Jan. 29, 2015

(54) VACUUM HEAT INSULATING PANEL AND METHOD FOR MANUFACTURING SAME

(71) Applicants: HAIER GROUP CORPORATION, Qingdao, Shandong (CN); QINGDAO HAIER JOINT STOCK CO., LTD, Qingdao, Shandong (CN)

(72) Inventors: Kui Zhang, Qingdao (CN); Liyan Wang, Qingdao (CN); Xiaobing Zhu, Qingdao (CN); Jingjing Zhang, Qingdao (CN)

(21) Appl. No.: 14/382,218

(22) PCT Filed: Dec. 26, 2012
(86) PCT No.: PCT/CN2012/087511

§ 371 Date: Aug. 29, 2014

(30) Foreign Application Priority Data
Jun. 13, 2012 (CN) 201210193303.0

(51) Int. Cl. F16L 59/065; B32B 37/10; B32B 37/14; F16L 59/04; C03C 13/00

(52) U.S. Cl. CPC F16L 59/065; F16L 59/04; C03C 13/00; B32B 37/142; B32B 37/1018
USPC 428/69; 156/62.4

(57) ABSTRACT

A vacuum heat insulating panel comprises outer wrapping material and core material. A getter is provided in the core material. The outer wrapping material is made by compounding wrapped material without aluminum foil on one side or both sides. The core material is made of an aggregate of glass fiber with uniform laminated structure, and the diameter of the glass fiber is 1-3 μm. A method for manufacturing the vacuum heat insulating panel is also disclosed. Due to very high vacuum degree in the vacuum heat insulating panel, the heat transferring speed is reduced. And, because of the outer wrapping material without aluminum foil layer, the edge thermal bridge effect is eliminated and the heat insulation effect is very good.

### CROSS-REFERENCE TO RELATED APPLICATION

This application claims the priority to Chinese Patent Application No. 201210193303.0, filed on Jun. 13, 2012 in the State Intellectual Property Office of P.R. China, entitled “VACUUM HEAT-INSULATING PANEL AND METHOD FOR MANUFACTURING SAME”, by Kui Zhang et al., which is hereby incorporated herein in its entirety by reference.

### FIELD OF THE INVENTION

The present invention relates generally to the field of heat-insulating materials, and more particularly, to a vacuum heat-insulating panel that can be used in a heat-preserving and heat-insulating product and a method for manufacturing the same.

### BACKGROUND OF THE INVENTION

During heat transfer, a heat preserving material has a high heat conductivity coefficient, which results in severe heat loss in a refrigerator. Conventionally, vacuum heat-insulating panels used in batches by refrigerator companies to ensure heat preservation of products mainly have two problems: (1) a composite material including an aluminum foil layer is usually used as an outer packing layer, which unavoidably causes a thermal bridge effect that heat is transferred through the outer wrapping layer to another surface, and results in a poor heat insulation effect of a vacuum heat-insulating panel, as shown in FIG. 1; and (2) a core layer is mainly manufactured by using a traditional wet process. Glass fibers of the core layer are arranged in a random order, and many erect fibers act as a medium of heat transfer; therefore, heat transfer cannot be prevented effectively, as shown in FIG. 2.

A vacuum heat-insulating panel includes three parts: an inner core layer (usually an assembly of glass fibers), an outer wrapping layer (usually a composite material with low gas permeability and water vapor permeability), and a getter (usually calcium oxide that absorbs water) placed inside. A vacuum degree of the vacuum panel directly affects the heat preservation effect, and the inner glass fiber assembled core layer has the greatest impact on the vacuum degree of the vacuum panel. Currently, wet-processed core layers are usually used. According to an analysis on heat resistance during heat transfer, fibers of a wet-processed core layer manufactured according to the prior art are arranged in a random order, which there exist voids and erect fibers. In an existing vacuum heat-insulating panel, heat is transferred from one end of the vacuum heat-insulating panel to the other end during heat transfer. Because many fibers are arranged erectly, heat is easily transferred through voids between the fibers and the erect fibers, the vacuum heat-insulating panel cannot effectively prevent from heat transferring, and a great amount of heat is leaked, which results in a high heat conduction coefficient and reduction of the heat preservation effect of the vacuum panel. As a result, a heat preservation function cannot be achieved effectively.

In addition, the outer wrapping layer is made of a composite material including aluminum foils; therefore, a thermal bridge effect occurs easily, and heat is directly transferred through the surface of the vacuum heat-insulating panel, instead of the vacuum heat-insulating panel, which results in a poor effect of the overall heat preservation.

Therefore, a heretofore unaddressed need exists in the art to address the aforementioned deficiencies and inadequacies.

### SUMMARY OF THE INVENTION

The invention provides a vacuum heat-insulating panel, which can solve a problem of the poorly heat preservation effect in the prior art, and a method for manufacturing the vacuum heat-insulating panel.

To solve the foregoing problem, the present invention adopts the following technical solutions:

In one aspect of the invention, a vacuum heat-insulating panel is provided, which includes an outer wrapping layer and a core layer, where a getter is provided inside the core layer, a composite wrapping layer of which one surface or two surfaces do not include aluminum foils is used as the outer wrapping layer, and the core layer is an assembly of glass fibers that has a uniform laminated structure, where the diameter of the glass fibers is 1 μm to 3 μm. The getter is formed of calcium oxide.

In one embodiment, when the wrapping layer of which one surface does not include an aluminum foil is used as the outer wrapping layer, one surface is made of NY15/MPET12/MEVOH15/PE50, and the other surface is made of NY15/MPET12/Al7/PE50; or one surface is made of PET12/NY25/Al6/HDPE50, and the other surface is made of NY25/MPET12/MEVOH12/HDPE50, where the numerals indicate thicknesses of the materials in the unit of μm.

In another embodiment, when the wrapping layer of which two surfaces do not include aluminum foils is used as the outer wrapping layer, both of the two surfaces are made of NY15/MPET12/MEVOH15/PE50, or both of the two surfaces are made of NY25/MPET12/MEVOH12/HDPE50, where the numerals indicate thicknesses of the materials, in the unit of μm.

In another aspect of the invention, a method for manufacturing a vacuum heat-insulating panel is provided, which includes the following steps:

(a) manufacturing a core layer, comprising pouring molten glass at a high temperature of 1100° C. to 1300° C. into a centrifugal head spinning at a high speed, where the spinning speed of the centrifugal head is 2000 rpm to 2500 rpm, flinging out fiber filaments, and then forming a uniform laminated structure by using a bottom suction apparatus, where the diameter of the fiber filament is 1 μm to 3 μm;

(b) wrapping with an outer wrapping layer, comprising placing a calcium oxide getter inside the core layer, wrapping the core layer with a composite wrapping layer of which one surface or two surfaces do not include aluminum foils, and then performing heat sealing on the outer wrapping layer; and

(c) vacuumizing the core layer sealed by the outer wrapping layer in step (b), and then forming a vacuum heat-insulating panel.

In one embodiment, the molten glass includes the following ingredients by weight percentage: silicon dioxide 60% to 80%, aluminum oxide 3% to 5%, magnesium oxide 3% to 5%, calcium oxide 5% to 10%, boron oxide 5% to 10%, and other oxides 4% to 20%.

In one embodiment, the other oxide includes sodium oxide.

In one embodiment, the suction apparatus includes, from top to bottom, an air extracting pump, an aluminum panel, a shell iron panel, and an air-permeable adhesive tape. A hole is provided on a corresponding central position of both the shell iron panel and the aluminum panel, the air extracting pump is disposed above the hole of the aluminum panel, the bottom of the aluminum panel is clad by the shell iron panel, the air-permeable adhesive tape is pasted under the hole of the shell iron panel, and the air-permeable adhesive tape and the shell iron panel are secured to each other by using a double-faced adhesive tape.

When the wrapping layer of which one surface does not include an aluminum foil is used as the outer wrapping layer, one surface is made of NY15/MPET12/MEVOH15/PE50, and the other surface is made of NY15/MPET12/Al7/PE50; or one surface is made of PET12/NY25/Al6/HDPE50, and the other surface is made of NY25/MPET12/MEVOH12/HDPE50, where the numerals indicate thicknesses of the materials, in the unit of μm.

When a wrapping layer of which two surfaces do not include aluminum foils is used as the outer wrapping layer, both of the two surfaces are made of NY15/MPET12/MEVOH15/PE50, or both of the two surfaces are made of NY25/MPET12/MEVOH12/HDPE50, where the numerals indicate thicknesses of the materials, in the unit of μm.

In the disclosure, NY represents nylon, MPET represents modified polyethylene terephthalate, MEVOH represents modified ethylene-vinyl alcohol copolymer, PE represents polyethylene, HDPE represents high density polyethylene, and PET represents polyethylene terephthalate. NY15 refers to a nylon material with the thickness of 15 μm, and the others can be deducted by analogy.

Among other things, the present invention improves an outer wrapping layer and a core layer in the following two aspects:

1. Outer wrapping layer: A wrapping layer of which one surface or two surfaces do not include aluminum foils is used, which prevents occurrence of a thermal bridge effect.

2. Core layer: An assembly of laminated glass fibers which are uniformly distributed and are fine is produced by using a new process, which can effectively prevent heat transfer.

In the process for manufacturing the core layer according to one embodiment, high-temperature molten glass is poured into a centrifugal head spinning at a high speed, and fiber filaments are flung out. A uniform laminated structure is formed by using a bottom suction apparatus, and then encapsulating and molding are performed.

In certain embodiments, main ingredients of the molten glass are silicon dioxide, aluminum oxide, magnesium oxide, and calcium oxide. During conduction, heat is effectively blocked by horizontal fibers, and therefore cannot be quickly transferred from one side of the panel to the other side. The vacuum heat-insulating panel can effectively prevent heat transfer.

The vacuum heat-insulating panel according to the present invention has the following advantages:

1. The glass fibers of the core layer are laminated and uniformly distributed.

2. The diameters of the glass fibers of the core layer is less than 3 μm.

3. A new composite material, which has no metal layer or has no metal layer on one surface, is used as the outer wrapping layer, thereby preventing a thermal bridge effect.

In addition, compared with the prior art, the present invention has the following advantages and effects:

When heat is to be transferred from the outside into a refrigerator and passes through a heat preserving layer of a body of the refrigerator, because of high vacuum degree inside the vacuum heat-insulating panel, the heat is blocked layer by layer by the glass fibers in the core layer during transfer, thereby greatly reducing a heat transfer speed and providing a good heat preservation effect; besides, the wrapping layer has no aluminum foil layer, which eliminates an edge effect. Therefore, the vacuum heat-insulating panel provides a good heat preservation effect.

A heat conductivity coefficient of a vacuum heat-insulating panel manufactured according to the present invention is usually less than 0.002 W/m·K, which can great improve heat preservation performance and reduce energy consumption of a refrigerator by more than 5%.

### BRIEF DESCRIPTION OF THE DRAWINGS

FIG. 1 is a schematic diagram of heat transfer in an existing vacuum heat-insulating panel with an outer wrapping layer including aluminum foils;

FIG. 2 is a schematic diagram of heat conduction in an existing core layer being a glass fiber assembly;

FIG. 3 is a schematic diagram of heat transfer in a vacuum heat-insulating panel with an outer wrapping layer of which one surface does not include an aluminum foil according to one embodiment of the present invention;

FIG. 4 is a schematic diagram of heat conduction in a core layer being a glass fiber assembly having a uniform laminated structure according to one embodiment of the present invention;

FIG. 5 is a schematic flowchart of a method for manufacturing a core layer of a vacuum heat-insulating panel according to one embodiment of the present invention; and

FIG. 6 is a schematic structural diagram of a suction apparatus.

### LIST OF REFERENCE NUMERALS

1. Centrifugal head; 2. Suction apparatus; 21. Air extracting pump; 22. Aluminum panel; 23. Shell iron panel; 24. Air-permeable adhesive tape; 25. Double-faced adhesive tape; 3. Fiber filament.

### DETAILED DESCRIPTION OF THE INVENTION

The present invention is further described in detail with reference to the accompanying drawings and embodiments in the following.

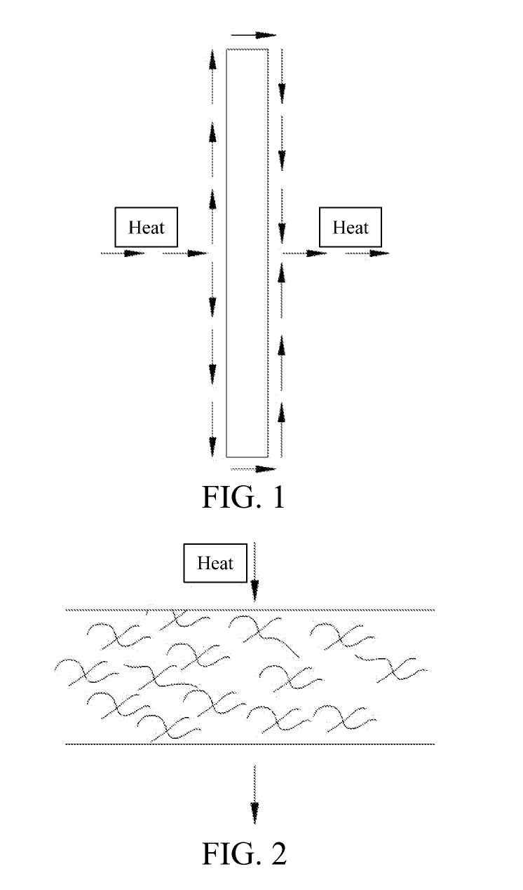

As shown in FIG. 1, a composite material including aluminum foils is used as an outer wrapping layer of an existing vacuum heat-insulating panel. During transfer, heat is directly transferred through the material to another surface, which is referred to as a thermal bridge effect and results in a poor heat insulation effect.

As shown in FIG. 2, glass fibers of an inner core layer of an existing vacuum heat-insulating panel are arranged in a random order; many erect fibers act as a medium of heat transfer, and heat is directly conducted through the fibers, which cannot effectively prevent heat transfer and results in a poor heat insulation effect.

The invention provides a new vacuum heat-insulating panel, which can simultaneously solve the foregoing problems.

In one aspect of the invention, a vacuum heat-insulating panel is provided, which includes an outer wrapping layer and a core layer, where a getter is provided inside the core layer, a composite wrapping layer of which one surface or two surfaces do not include aluminum foils is used as the outer wrapping layer, and the core layer is an assembly of glass fibers that has a uniform laminated structure, where the diameter of the glass fiber is 1 μm to 3 μm. In one embodiment, calcium oxide is used as the getter.

### EMBODIMENT 1

A vacuum heat-insulating panel is provided, which includes an outer wrapping layer and a core layer, where a calcium oxide getter is provided inside the core layer, and a wrapping layer of which one surface does not include an aluminum foil is used as the outer wrapping layer, where one surface is made of NY15/MPET12/MEVOH15/PE50, which are respectively nylon with the thickness of 15 μm, modified polyethylene terephthalate with the thickness of 12 μm, modified ethylene-vinyl alcohol copolymer with the thickness of 15 μm, and polyethylene with the thickness of 50 μm, and the other surface is made of NY15/MPET12/Al7/PE50, which are respectively nylon with the thickness of 15 μm, modified polyethylene terephthalate with the thickness of 12 μm, aluminum with the thickness of 17 μm, and polyethylene with the thickness of 50 μm.

### EMBODIMENT 2

A vacuum heat-insulating panel is provided, which includes an outer wrapping layer and a core layer, where a calcium oxide getter is provided inside the core layer, and a wrapping layer of which one surface does not include an aluminum foil is used as the outer wrapping layer, where one surface is made of PET12/NY25/Al6/HDPE50, and the other surface is made of NY25/MPET12/MEVOH12/HDPE50.

### EMBODIMENT 3

A vacuum heat-insulating panel is provided, which includes an outer wrapping layer and a core layer, where a calcium oxide getter is provided inside the core layer, a wrapping layer of which two surfaces do not include aluminum foils is used as the outer wrapping layer, and both of the two surfaces are made of NY15/MPET12/MEVOH15/PE50, where the numerals indicates thicknesses, in the unit of μm.

### EMBODIMENT 4

A vacuum heat-insulating panel is provided, which includes an outer wrapping layer and a core layer, where a calcium oxide getter is provided inside the core layer, and when a wrapping layer of which two surfaces do not include aluminum foils is used as the outer wrapping layer, both of the two surfaces are made of NY25/MPET12/MEVOH12/HDPE50.

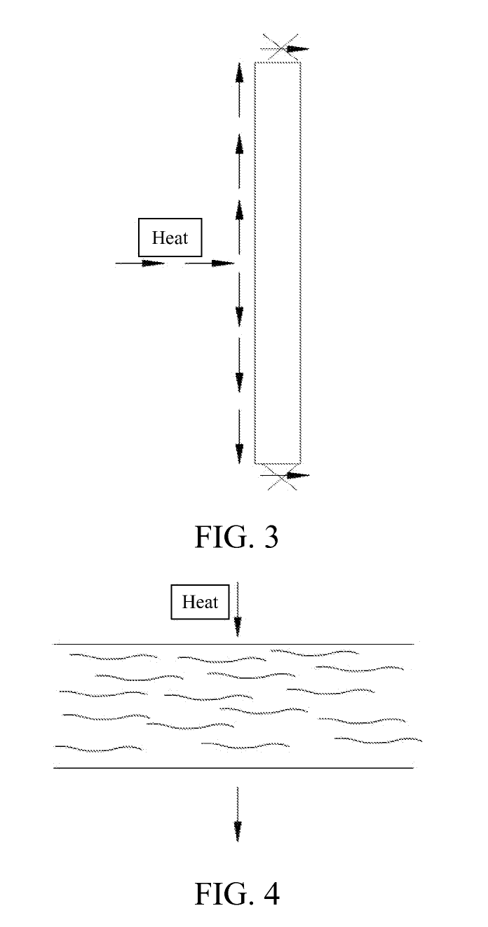

As shown in FIG. 3, during heat transfer, a vacuum heat-insulating panel according to the present invention does not cause a thermal bridge effect and has a good heat insulation effect because a composite material of which one surface does not include an aluminum foil is used as an outer wrapping layer; certainly, when a wrapping layer of which two surfaces do not include aluminum foils is used, the thermal bridge effect is not caused either.

As shown in FIG. 4, glass fibers of a core layer according to the present invention forms a uniform laminated structure; during transfer, heat is effectively blocked by horizontal fibers and cannot be quickly transferred from one side of a panel to the other side, which can effectively prevent heat transfer and provides a good heat insulation effect.

By using the foregoing outer wrapping layer and core layer, heat preservation performance of a vacuum heat-insulating panel according to the present invention is greatly improved with heat conductivity coefficient being less than 0.002 W/m·K.

In another aspect of the invention, a method for manufacturing the vacuum heat-insulating panels in the foregoing EMBODIMENTS 1-4 is provided, which includes the following steps:

(1) manufacturing a core layer, comprising pouring molten glass at a high temperature of 1100° C. to 1300° C. into a centrifugal head spinning at a high speed, where the spinning speed of the centrifugal head is 2000 rpm to 2500 rpm, flinging out fiber filaments, and then forming a uniform laminated structure by using a bottom suction apparatus, where the diameter of the fiber filament is 1 μm to 3 μm;

(2) wrapping with an outer wrapping layer, comprising placing a calcium oxide getter inside the core layer, wrapping the core layer with a composite wrapping layer of which one surface or two surfaces do not include aluminum foils, and then performing heat sealing on the outer wrapping layer; and

(3) vacuumizing the core layer sealed by the outer wrapping layer in step (2), and then forming a vacuum heat-insulating panel.

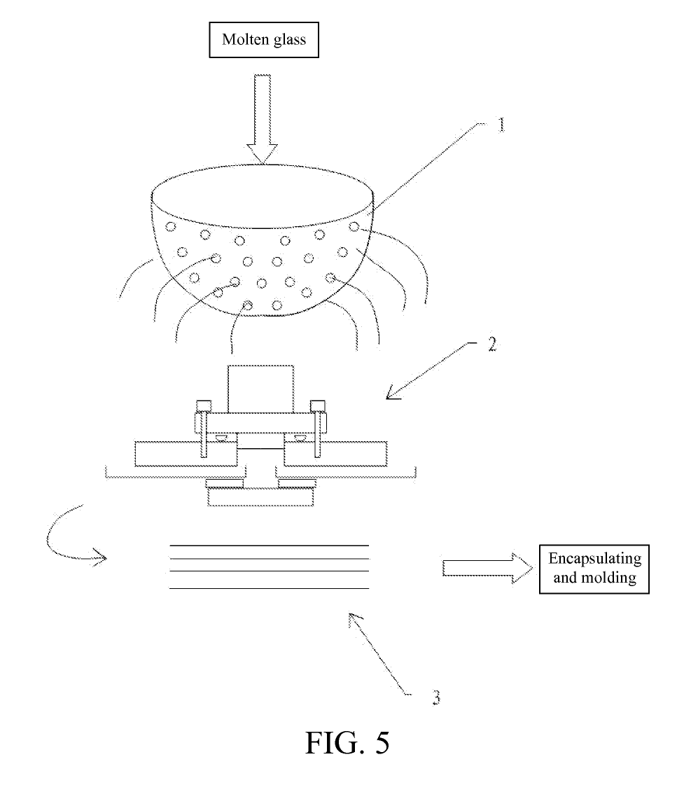

FIG. 5 is a flowchart of a process for manufacturing a core layer according to one embodiment of the present invention. High-temperature molten glass is poured into a centrifugal head 1, where the centrifugal head 1 spins at a high speed of 2000 rpm to 2500 rpm, fiber filaments are flung out, and the fiber filaments that are flung out form a uniform laminated structure after passing through a suction apparatus 2, and then encapsulating and molding are performed. Because the fiber filaments are suctioned by the suction apparatus and form a uniform laminated structure, during heat transfer, heat is blocked layer by layer by the laminated fiber filaments, thereby greatly reducing a heat transfer speed and providing a good heat preservation effect.

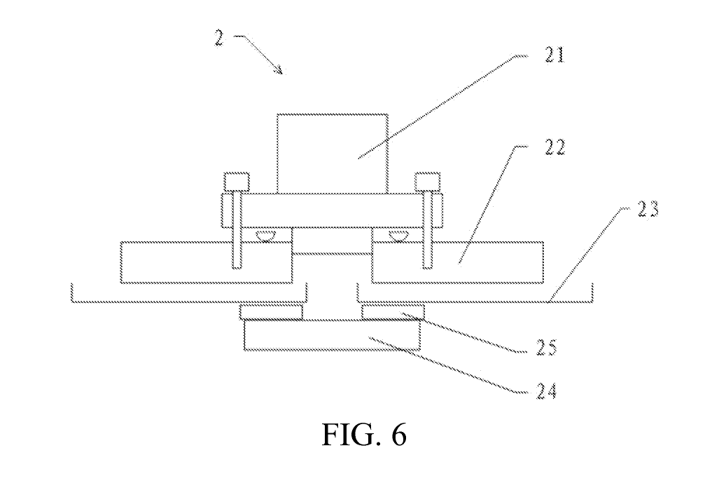

As shown in FIG. 6, a suction apparatus 2 includes, from top to bottom, an air extracting pump 21, an aluminum panel 22, a shell iron panel 23, and an air-permeable adhesive tape 24. A hole is provided on a corresponding central position of both the aluminum panel 22 and the shell iron panel 23, the air extracting pump 21 is secured above the hole of the aluminum panel 22 by using a screw, the bottom of the aluminum panel 22 is clad by the shell iron panel 23, the air-permeable adhesive tape 24 is pasted under the hole of the shell iron panel 23, and the air-permeable adhesive tape 24 and the shell iron panel 23 are secured to each other by using a double-faced adhesive tape 25.

In the manufacturing method, the molten glass includes the following ingredients by weight percentage: silicon dioxide 70%, aluminum oxide 4%, magnesium oxide 4%, calcium oxide 5%, boron oxide 5%, and sodium oxide 12%.

In one embodiment, when the wrapping layer of which one surface does not include an aluminum foil is used as the outer wrapping layer, one surface is made of NY15/MPET12/MEVOH15/PE50, and the other surface is made of NY15/MPET12/Al7/PE50; or one surface is made of PET12/NY25/Al6/HDPE50, and the other surface is made of NY25/MPET12/MEVOH12/HDPE50, where the numerals indicate thicknesses of the materials, in the unit of μm.

In another embodiment, when the wrapping layer of which two surfaces do not include aluminum foils is used as the outer wrapping layer, both of the two surfaces are made of NY15/MPET12/MEVOH15/PE50, or both of the two surfaces are made of NY25/MPET12/MEVOH12/HDPE50, where the numerals indicate thicknesses of the materials, in the unit of μm.

The foregoing embodiments are merely preferred embodiments of the present invention rather than limitations in other forms to the present invention. Any person skilled in the art may make an equivalent variation or modification according to the foregoing disclosed technical content, to obtain an equivalent embodiment. However, all simple changes and equivalent variations and modifications made to the foregoing embodiments according to the technical essence of the present invention and without departing from the content of the technical solutions of the present invention still fall within the protection scope of the technical solutions of the present invention.

What is claimed is:

1. A vacuum heat-insulating panel, comprising:
an outer wrapping layer; and
a core layer,
wherein a getter is provided inside the core layer, a composite wrapping layer of which one surface or two surfaces do not comprise aluminum foils is used as the outer wrapping layer, and the core layer is an assembly of glass fibers that has a uniform laminated structure, wherein the diameters of the glass fibers are 1 μm to 3 μm.

2. The vacuum heat-insulating panel according to claim 1, wherein when the wrapping layer of which one surface does not comprise an aluminum foil is used as the outer wrapping layer, the one surface is made of NY15/MPET12/MEVOH15/PE50, and the other surface is made of NY15/MPET12/Al7/PE50; or the one surface is made of PET12/NY25/Al6/HDPE50, and the other surface is made of NY25/MPET12/MEVOH12/HDPE50, wherein the numerals indicate thicknesses of the materials in the unit of μm.

3. The vacuum heat-insulating panel according to claim 1, wherein when the wrapping layer of which two surfaces do not comprise aluminum foils is used as the outer wrapping layer, both of the two surfaces are made of NY15/MPET12/MEVOH15/PE50, or both of the two surfaces are made of NY25/MPET12/MEVOH12/HDPE50, wherein the numerals indicate thicknesses of the materials in the unit of μm.

4. A method for manufacturing a vacuum heat-insulating panel, comprising the steps of:
(a) manufacturing a core layer, comprising pouring molten glass at a high temperature of 1100° C. to 1300° C. into a centrifugal head spinning at a high speed, wherein the spinning speed of the centrifugal head is 2000 rpm to 2500 rpm, flinging out fiber filaments, and forming a uniform laminated structure by using a bottom suction apparatus, wherein the diameter of the fiber filament is 1 μm to 3 μm;
(b) wrapping with an outer wrapping layer, comprising placing a calcium oxide getter inside the core layer, wrapping the core layer with a composite wrapping layer of which one surface or two surfaces do not comprise aluminum foils, and performing heat sealing on the outer wrapping layer; and
(c) vacuumizing the core layer sealed by the outer wrapping layer in step (b), and forming a vacuum heat-insulating panel.

5. The method for manufacturing a vacuum heat-insulating panel according to claim 4, wherein the molten glass comprises the ingredients by weight percentage: silicon dioxide 60% to 80%, aluminum oxide 3% to 5%, magnesium oxide 3% to 5%, calcium oxide 5% to 10%, boron oxide 5% to 10%, and another oxide 4% to 20%.
